(19) United States
(12) Patent Application Publication
(10) Pub. No.: US 2026/0130331 A1
(43) Pub. Date: May 14, 2026

(54) Self-Watering Plant Container Device

(71) Applicant: Daniel Finneran, Andover, MA (US)

(72) Inventor: Daniel Finneran, Andover, MA (US)

(21) Appl. No.: 19/356,301

(22) Filed: Oct. 13, 2025

Related U.S. Application Data
(60) Provisional application No. 63/719,376, filed on Nov. 12, 2024.

(51) Int. Cl. A01G 27/02; A01G 27/00

(52) U.S. Cl. CPC A01G 27/02; A01G 27/008

(57) ABSTRACT

A self-watering plant container device is provided. The device comprises an external hull and an internal hull arranged concentrically to form a passive water reservoir between them. The external hull includes a UV-stable transparent viewing window for monitoring water levels. The internal hull contains watering screens that enable capillary water transfer from the reservoir to the soil. In some embodiments, vertical watering slots are used instead of or alongside the screens to customize hydration profiles. The internal hull is secured to the external hull using structural fasteners such as radial support fins and a central bottom stanchion. Water may be added directly to the soil or poured into the reservoir via the outer hull. Excess water drains into the reservoir and is absorbed upward through capillary action. The viewing strip features visual markers for water management.

### CROSS-REFERENCE TO RELATED APPLICATION

The present application claims priority to, and the benefit of, U.S. Provisional Application No. 63/719,376, which was filed on Nov. 12, 2024, and is incorporated herein by reference in its entirety.

### FIELD OF THE INVENTION

The present invention relates generally to the field of plant containers. More specifically, the present invention relates to a plant container that delivers water to plant roots through capillary action using an internal hull with hydration screens or slots, supported by an integrated reservoir formed between concentric inner and outer hulls. A transparent viewing strip further allows users to monitor water levels, enabling consistent and low-maintenance plant hydration. Accordingly, the present disclosure makes specific reference thereto. Nonetheless, it is to be appreciated that aspects of the present invention are also equally applicable to other like applications, devices, and methods of manufacture.

### BACKGROUND

The proper hydration of potted plants presents a persistent challenge for plant owners, particularly due to the varying water needs of different plant species, environmental conditions, and stages of growth. Traditional plant pots require frequent manual watering, which can lead to either overwatering or underwatering. While a number of self-watering solutions have been introduced to address these concerns, many of these existing products utilize two separate hulls that are not conjoined. These configurations often depend on added components such as spouts, cotton wicks, or mechanical indicators to function, increasing both the complexity and the likelihood of mechanical failure. Additionally, these features frequently involve moving parts that may reduce product durability and increase manufacturing costs. For example, water level indicators composed of floating mechanisms within clear tubes introduce potential points of failure and increase production complexity. Furthermore, manual soil moisture checks remain necessary in many current designs, which reduces convenience and usability. As such, there remains a need for an improved solution that offers consistent hydration, simplified monitoring, and ease of use, while minimizing mechanical complexity.

Therefore, there exists a long-felt need in the art for a self-watering plant container device that enables consistent hydration without the use of mechanical parts. There also exists a long-felt need in the art for a self-watering plant container device that allows users to monitor water levels without disturbing the plant or soil. Moreover, there exists a long-felt need in the art for a self-watering plant container device that provides a durable and manufacturable structure using a single-piece construction method.

The subject matter disclosed and claimed herein, in one embodiment thereof, comprises a self-watering plant container device. The device is comprised of an external hull and an internal hull arranged concentrically to define an intermediate space functioning as a passive water reservoir. The external hull comprises a transparent viewing window constructed from UV-stable polymeric material that allows for direct observation of the water level within the reservoir. The internal hull comprises one or more watering screens that permit capillary movement of water from the reservoir to the soil contained within the internal hull. In one embodiment, the device further comprises vertical watering slots in lieu of or in addition to the sidewall screens, allowing further customization of water delivery profiles. The internal hull may be affixed to the external hull using structural fasteners such as radial support fins and a central bottom stanchion to maintain vertical clearance and water flow stability. Water may be introduced directly into the internal hull, allowing excess to drain into the reservoir, or poured along the inner wall of the external hull to fill the reservoir directly. Moisture is then drawn into the soil via passive capillary action through the screens and/or slots, ensuring consistent hydration. The viewing strip includes graduated visual markers to assist with water level management and may optionally include a buoyant indicator to provide dynamic feedback regarding reservoir status.

In this manner, the self-watering plant container device of the present invention accomplishes all the foregoing objectives and provides a passive plant hydration system that eliminates the need for moving parts, thereby enhancing durability and simplifying production. The inclusion of vertical screens and/or slots within the internal hull further ensures uniform water distribution, addressing the issue of inconsistent soil moisture. The transparent viewing strip, coupled with visual markers, facilitates intuitive water level monitoring without disturbing the soil, supporting accurate and consistent irrigation. By eliminating reliance on mechanical components and simplifying the watering process, the self-watering plant container device meets the long-standing need for a reliable, easy-to-use, and manufacturable self-watering solution suitable for a wide range of plant types and care environments.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a self-watering plant container device. The device is a passive self-watering plant container configured to deliver consistent hydration to plant roots through a built-in water reservoir and multiple hydration pathways. The configuration supports efficient moisture regulation using capillary action, making the device suitable for low-maintenance plant care and environments with inconsistent watering schedules.

The device is comprised of an external hull and an internal hull arranged concentrically to form an interior space functioning as a water reservoir. The external hull serves as the outer structure, wherein the internal hull holds the plant and soil and may be comprised of similar or different materials.

The internal hull is further comprised of at least one watering screen. One screen may be positioned at the bottom wall for soil support, while additional screens may be located along the vertical sidewall to create multiple hydration zones. In some embodiments, vertically oriented watering slots may be included in the internal hull wall, functioning as direct channels for water transfer.

The external hull may also include a transparent viewing window for water level monitoring. The window may be comprised of UV-stable, light-diffusing polymers and may feature protective tints to inhibit algae growth. Visual markers may be integrated into the viewing window to indicate critical water levels.

Water may be introduced to the device through multiple pathways, including pouring directly into soil positioned within the internal hull or into the interior space via the gap between the hulls. Excess water then drains through the bottom screen into the reservoir. Next, passive capillary action then moves water into the soil through the screens or slots, maintaining optimal soil moisture levels and supporting ambient humidity around the plant roots.

The internal hull may be mechanically affixed to the external hull using fasteners such as radial support fins and a central bottom stanchion. These fasteners stabilize the internal hull, maintain alignment, and preserve clearance above the reservoir base to ensure proper hydration function.

Accordingly, the self-watering plant container device of the present invention is particularly advantageous as it provides a passive plant hydration system that eliminates the need for moving parts, thereby enhancing durability and simplifying production. The inclusion of vertical screens and/or slots within the internal hull further ensures uniform water distribution, addressing the issue of inconsistent soil moisture. The transparent viewing strip, coupled with visual markers, facilitates intuitive water level monitoring without disturbing the soil, supporting accurate and consistent irrigation. By eliminating reliance on mechanical components and simplifying the watering process, the self-watering plant container device that overcomes the long-standing needs of existing plant containers known in the art for a reliable, easy-to-use, and manufacturable self-watering solution suitable for a wide range of plant types and care environments.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one potential embodiment of a self-watering plant container device of the present invention in accordance with the disclosed architecture;

FIG. 2 illustrates a side perspective view of an internal hall of one potential embodiment of a self-watering plant container device of the present invention in accordance with the disclosed architecture; and

FIG. 3 illustrates a side cross-sectional view of one potential embodiment of a self-watering plant container device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a self-watering plant container device that enables consistent hydration without the use of mechanical parts. There also exists a long-felt need in the art for a self-watering plant container device that allows users to monitor water levels without disturbing the plant or soil. Moreover, there exists a long-felt need in the art for a self-watering plant container device that provides a durable and manufacturable structure using a single-piece construction method.

The present invention, in one exemplary embodiment, is comprised of a self-watering plant container device. The device is designed to provide consistent root hydration by utilizing a built-in water reservoir and multiple hydration pathways. Through capillary action, the configuration enables efficient moisture regulation, offering a low-maintenance solution for plant care in environments with irregular watering schedules.

The device comprises an external hull and an internal hull arranged concentrically, forming an intermediate interior space that functions as a water reservoir. The external hull acts as the primary structural support, while the internal hull is configured to contain the soil and plant.

At least one watering screen is integrated into the internal hull. The screen may be positioned along the bottom wall to support the soil, with additional screens mounted on the vertical sidewalls to establish multiple hydration zones. In certain embodiments, vertically oriented watering slots may also be formed in the internal hull to serve as direct water transfer channels.

The external hull may further incorporate a transparent viewing window that enables visual water level assessment. This window may be comprised of UV-stable, light-diffusing polymers and may include protective tints to reduce algal growth. Visual markers may be embedded in the viewing window to indicate critical water levels within the reservoir.

Water can be introduced through multiple access points, either by pouring directly into the soil contained within the internal hull or by directing water into the space between the hulls. Surplus water drains through the bottom screen into the reservoir. Moisture is then passively drawn back into the soil via capillary action through the screens or slots, maintaining stable moisture levels and contributing to ambient humidity near the plant roots.

The internal hull may be secured to the external hull by mechanical fasteners such as radial support fins and a central bottom stanchion. These components provide structural alignment, support the suspended position of the internal hull, and preserve reservoir clearance necessary for consistent hydration.

As a result, the device eliminates the need for mechanical watering components, thereby improving durability and simplifying manufacturing. The integration of vertical screens and/or slots further ensures even moisture distribution throughout the soil. The inclusion of a transparent viewing strip with visual markers also enables straightforward water level monitoring without disturbing the plant or soil. Therefore, the self-watering nature of the device addresses long-standing challenges in plant container systems by delivering a reliable, easy-to-use, and scalable hydration solution suitable for diverse plant species and growing environments.

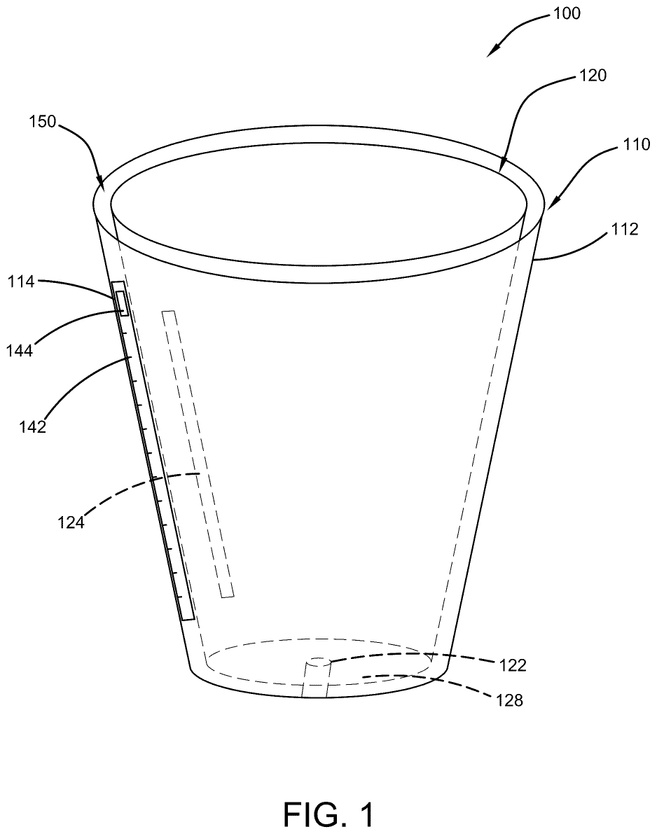

Referring initially to the drawings, FIG. 1 illustrates a side perspective view of one potential embodiment of a self-watering plant container device 100 of the present invention in accordance with the disclosed architecture. The device 100 is a passive self-watering plant container designed to provide consistent hydration to plant roots while minimizing user intervention and reducing the risk of overwatering. More specifically, the device 100 provides a plant container with a built-in water reservoir and multiple soil hydration pathways, to support plant health across various environmental conditions. The configuration allows water to be stored and gradually delivered to the plant's root system through capillary action, ensuring efficient moisture regulation. This design is particularly advantageous for users seeking low-maintenance plant care solutions, environments with inconsistent watering schedules, or applications requiring controlled irrigation over extended periods.

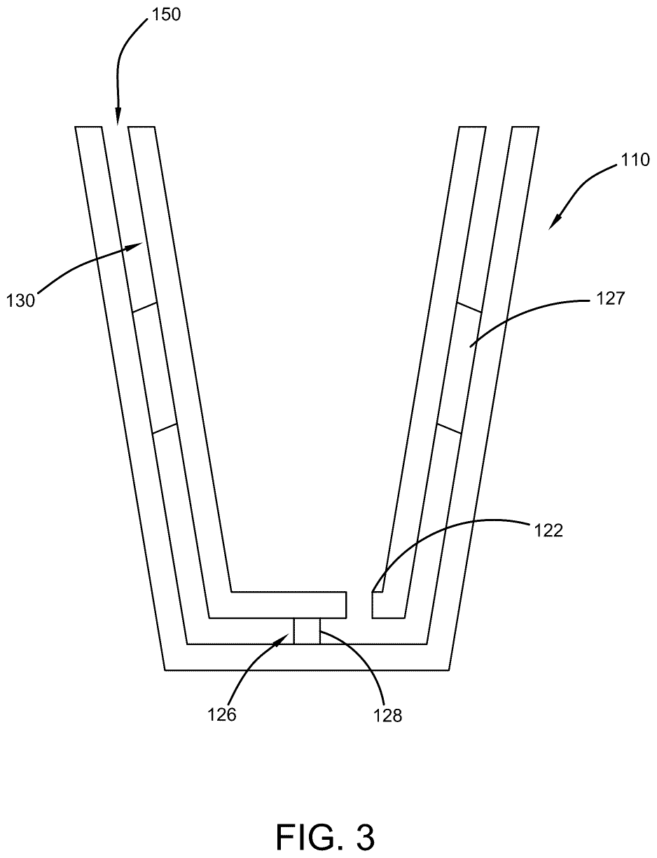

The device 100 is comprised of an external hull 110 and an internal hull 120, which are concentrically arranged to define an interior space 130 between the same that functions as a self-contained watering reservoir, as seen in FIG. 1 and FIG. 3. The width of the interior space 130 may remain consistent throughout the vertical height of the device 100, allowing uniform water distribution. The external hull 110 serves as the structural outer shell of the device and may be comprised of but not limited to rigid polymeric materials, thermoplastics, ceramic composites, or lightweight metals. The internal hull 120 is configured to hold the soil and plant roots and may be comprised of similar or contrasting materials to the external hull 110.

The internal hull 120 may be comprised of at least one watering screen 122. The screen 122 may be any type of screen such as but not limited to any combination of a cross-grid screen, a woven mesh screen, a perforated plate screen, a sintered fiber mat, or a punched metal screen. Each screen 122 type may vary in mesh size, material composition, and geometry to accommodate different soil retention characteristics and capillary flow rates. In one embodiment, a screen 122 is positioned on a bottom wall 125 of the internal hull 120 to provide foundational soil support. Additional watering screens 122 may be positioned along the vertical sidewall 123 of the internal hull 120, wherein said screens 122 are positioned to create multiple zones through which water from the interior space 130 may enter a soil stored within the internal hull 120. The vertical watering screens 122 may be arranged in any pattern/arrangement, including but not limited to staggered rows or helical patterns to promote even hydration throughout the root zone. The variation in screen 122 elevation on the wall 123 may further allow users to regulate the passive hydration level by adjusting the amount of water introduced into the device 100, thereby tailoring the moisture exposure to specific plant types, growth stages, or environmental conditions.

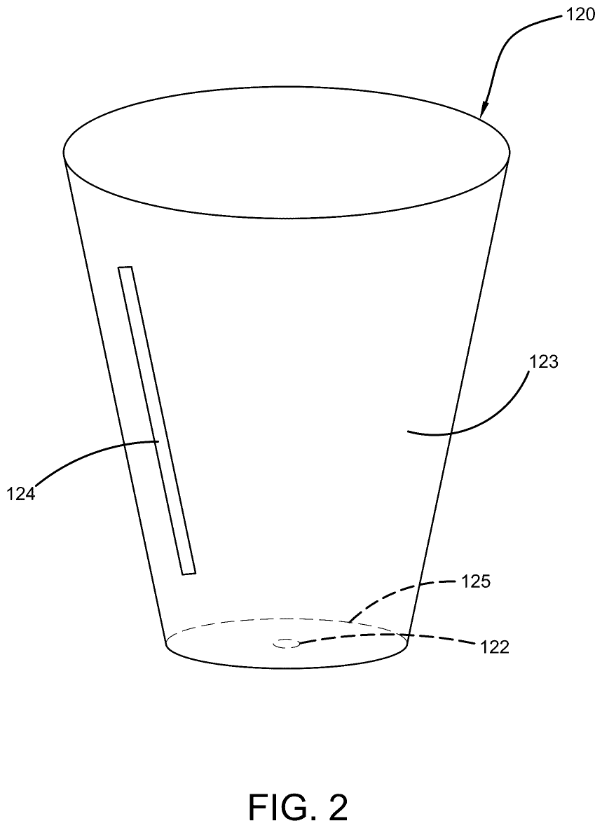

In one embodiment, the device 100 may include vertically oriented watering slots 124 instead of or in addition to the vertical screens 122 positioned within the vertical walls 123 of the internal hull 120 and that function as direct channels for water transfer, as seen in FIG. 2 and FIG. 1. The slots 124 may vary in number, spacing, and height, allowing for customization of hydration profiles depending on the intended plant species. For example, slots 124 may be spaced more densely near the lower portion of the wall 123 for moisture-loving plants or positioned higher for species requiring minimal root-zone saturation.

The sidewall 112 of the external hull 110 may further be comprised of a transparent viewing window 114, as seen in FIG. 1. The window 114 may extend along any amount of the side wall 112. The window 114 may be made from a UV-stable, light-diffusing polymer and may be tinted in a range of protective colors such as but not limited to amber, green, black, smoke gray, etc. to prevent algal growth and degradation caused by light exposure. The viewing window 114 enables the user to visually monitor the water level within the interior space 130 without disturbing the soil or plants. Integrated into the viewing window 114 may be a plurality of visual markers 142 in the form of but not limited to lines, symbols, letters, words, icons, or graduated color gradients. The markers 142 may correspond to critical water levels within the internal hull 120, including but not limited to the bottom of the internal hull 120, the midpoint of the internal hull 120, the upper edge of the vertical watering slots 124, the lower edge of the vertical watering slots 124, and the maximum fill level of the interior space 130. The markers 142 allow for intuitive water management and reduce the risk of over-or under-watering. In additional embodiments, the viewing window 114 may feature a built-in mechanical water level indicator 144 in the form of (but not limited to) a clear tube with a buoyant core. As the water level in the interior space 130 changes, the core rises or falls within the tube, providing an active, dynamic indication of water availability.

Water may be introduced into the device 100 through multiple pathways. More specifically, water can be poured water directly into the soil located within the internal hull 120. In this scenario, excess water that exceeds the capacity of the soil drains downward through the bottom screen 122 and collects in the surrounding interior space 130. Alternatively, water may be introduced directly into the interior space 130 via the gap 150 between the external 110 and internal hulls 120.

As water accumulates in the interior space 130, passive capillary action draws moisture upward through the watering screens 122 and/or slots 124 and into the surrounding soil. The rate of capillary movement may vary based on screen material, soil composition, and ambient humidity. This self-regulating system helps maintain consistent soil moisture while minimizing the likelihood of root rot or fungal overgrowth associated with excessive water accumulation. Evaporation from the interior space 130 also contributes to ambient humidity near the plant roots. Evaporating water can also be used by plants such as orchids, which have aerial roots.

In one embodiment, the internal hull 120 may be mechanically affixed to the external hull 110 through at least one fastener 126. The fastener 126 may include but is not limited to any combination of radial support fins 127 and a central bottom stanchion 128, as seen in FIG. 1 and FIG. 3. The support fins 127 provide lateral stability, maintain the alignment of the internal hull 120 within the external hull 110, and allow water to flow freely within the interior space 130. The fins 127 may be integrally molded or mechanically attached, and may vary in number and shape, such as straight, curved, or tapered. The bottom stanchion 128 centers the internal hull 120 and may be integrally molded to form a rigid structural anchor. These features ensure that the internal hull 120 remains suspended above the base of the external hull 110 to maintain reservoir clearance and consistent hydration functionality.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “self-watering plant container device” and “device” are interchangeable and refer to the self-watering plant container device 100 of the present invention.

Notwithstanding the foregoing, the self-watering plant container device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the self-watering plant container device 100 as shown in the FIGS. are for illustrative purposes only, and that many other sizes and shapes of the self-watering plant container device 100 are well within the scope of the present disclosure. Although the dimensions of the self-watering plant container device 100 are important design parameters for user convenience, the self-watering plant container device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A self-watering plant container device comprising:
an external hull;
an internal hull concentrically arranged within the external hull to define an interior space between the external hull and the internal hull, wherein the interior space functions as a water reservoir; and
a watering screen positioned on the internal hull.

2. The self-watering plant container device of claim 1, wherein the watering screen is positioned on a bottom wall of the internal wall.

3. The self-watering plant container device of claim 1, wherein the watering screen is positioned on a vertical wall of the internal wall.

4. The self-watering plant container device of claim 1, wherein the internal hull is comprised of a fin.

5. The self-watering plant container device of claim 1 further comprised of a sanction.

6. A self-watering plant container device comprising:
an external hull;
an internal hull concentrically arranged within the external hull to define an interior space between the external hull and the internal hull, wherein the interior space functions as a water reservoir; and
a watering screen positioned on the internal hull; and
a watering slot positioned within a vertical sidewall of the internal hull.

7. The self-watering plant container device of claim 6, wherein the watering slot is comprised of a vertical slot.

8. The self-watering plant container device of claim 6, wherein the transparent viewing window is comprised of a tinted, colored material.

9. The self-watering plant container device of claim 6, wherein the transparent viewing window is comprised of a visual marker.

10. A self-watering plant container device comprising:
an external hull;
an internal hull concentrically arranged within the external hull to define an interior space between the external hull and the internal hull, wherein the interior space functions as a water reservoir; and
a watering screen positioned on the internal hull;
a watering slot positioned within a first vertical sidewall of the internal hull; and
a transparent viewing window positioned on a second vertical sidewall of the external hull.

11. The self-watering plant container device of claim 10, wherein the transparent viewing window is comprised of a tinted, colored material.

12. The self-watering plant container device of claim 10, wherein the transparent viewing window is comprised of a visual marker.

13. The self-watering plant container device of claim 12, wherein the visual marker is comprised of a line, a symbol, a letter, a word, an icon, or a graduated color gradient.

14. The self-watering plant container device of claim 12, wherein a position of the vertical marker on the transparent viewing window corresponds to a bottom of the internal hull.

15. The self-watering plant container device of claim 12, wherein a position of the vertical marker on the transparent viewing window corresponds to a midpoint of the internal hull.

16. The self-watering plant container device of claim 12, wherein a position of the vertical marker on the transparent viewing window corresponds to an upper edge of the watering slot.

17. The self-watering plant container device of claim 12, wherein a position of the vertical marker on the transparent viewing window corresponds to a lower edge of the watering slot.

18. The self-watering plant container device of claim 10, wherein the transparent viewing window is comprised of a water level indicator.

19. The self-watering plant container device of claim 18, wherein the water level indicator is comprised of a clear tube with a buoyant core.

20. The self-watering plant container device of claim 11, wherein the tinted, colored material is comprised of an amber, a green, a black, or a smoke gray.
